(19) United States
(12) Patent Application Publication
(10) Pub. No.: US 2025/0031712 A1
(43) Pub. Date: Jan. 30, 2025

(54) METHOD FOR MAKING VEGETABLE CHEESE USING ALMONDS

(71) Applicant: Armored Fresh. Inc, Seoul (KR)

(72) Inventors: Yong Kuk Park, Hwaseong-si (KR); Geunseo Yang, Seoul (KR)

(73) Assignee: Armored Fresh. Inc, Seoul (KR)

(21) Appl. No.: 18/250,159

(22) PCT Filed: Feb. 3, 2023
(86) PCT No.: PCT/KR2023/001599

§ 371 Date: Apr. 21, 2023

(30) Foreign Application Priority Data
Feb. 7, 2022 (KR) 10-2022-0015405
Apr. 14, 2022 (KR) 10-2022-0046147

(51) Int. Cl. A23C 20/02; A23L 25/00

(52) U.S. Cl. CPC A23C 20/02; A23L 25/40

(57) ABSTRACT

A method for making vegetable cheese using almonds according to an exemplary embodiment of the present invention includes an almond washing-soaking-hull removal process of sorting/washing almonds to remove the skin, an almond extraction process for producing almond milk by extracting almonds after the almond washing-soaking-hull removal process, a protein enrichment process for enhancing almond protein in the almond milk extracted from the almond extraction process, a almond milk fermentation process for producing vegetable fermented almond milk by using vegetable lactic acid bacteria in the almond milk produced from the protein enrichment process, a raw material measuring and adding process for weighing almond milk, coconut oil, modified starch, stabilizer, acidity regulator, salt, and paprika extract produced from the almond milk fermentation process, a sterilization & emulsification process of cooking/emulsifying/sterilizing the raw materials weighed in the raw material measuring and adding process by putting them into a cheese cooker, a cooling & packaging process for transporting the colloidal emulsification/sterilization liquid prepared from the sterilization & emulsification process to a packaging machine and packaging/cooling, and a ripening process for aging the vegetable cheese produced from the cooling & packaging process.

### TECHNICAL FIELD

The present invention relates to a method for making vegetable cheese using almonds, which is a method for manufacturing 100% vegetable vegan cheese using almonds, which are rich in minerals and dietary fiber among nuts and can greatly help improve the eating habits of modern people, wherein a process is similar to the process of natural cheese, but as a method of producing vegetable cheese after producing almond milk through almond extract rather than milk while in general, natural cheese is produced from cow's milk, that can most similar to natural cheese made from cow's milk in taste and nutritional content by reinforcing taste and nutrients, especially protein, which are the biggest disadvantages of vegetable cheese made with modified starch.

### BACKGROUND ART

Examples of cheeses having a working process during the manufacturing process include pasta filata cheeses such as mozzarella, provolone, scamorcha, and cacciocavalo (pasta: cheese curd in Italian; pifatura: means to knead in Italian). In addition, in Japan, a cheese that has elasticity and is torn like a rice cake spread is known as string cheese.

Specifically, as a feature of the manufacturing method of these cheeses, they have a process of plasticizing the cheese curd by adding hot water (kneading bath) to the cheese curd prepared from the raw milk and working (kneading, stretching) it.

By going through such a working process, cheese having a unique texture with elasticity like a rice cake is obtained, but in order to provide a higher quality product, it has been desired to improve undesirable textures such as gum-like stickiness, hard rubber-like texture (chewy) that is difficult to chew, and that remain in the mouth when baked and eaten.

Thus, the present invention is to provide a method for manufacturing 100% vegetable vegan cheese using almonds, which are rich in minerals and dietary fiber among nuts, and can greatly help improve the eating habits of modern people.

### RELATED ART LITERATURE

### Patent Literature

Patent Application Publication No. 10-2021-0055264

### DETAILED DESCRIPTION OF THE INVENTION

### Technical Problem

The present invention is directed to providing a method to make the flavor and nutrients most similar to natural cheese made from cow's milk by reinforcing the taste and nutrients, especially proteins, which are disadvantages of vegetable cheese made with modified starch by producing 100% vegetable cheese after making almond milk by extracting almonds rich in minerals, dietary fiber and protein, after emulsifying/sterilizing by adding coconut oil, modified starch, stabilizer, acidity regulator, salt, and paprika extract, and packing and aging the emulsion after emulsification/sterilization.

### Means to Solve the Problem

Method for making vegetable cheese using almonds according to an exemplary embodiment of the present invention includes: an almond washing-soaking-hull removal process of sorting/washing almonds to remove the skin; an almond extraction process for producing almond milk by extracting almonds after the almond washing-soaking-hull removal process; a protein enrichment process for enhancing almond protein in the almond milk extracted from the almond extraction process; a almond milk fermentation process for producing vegetable fermented almond milk by using vegetable lactic acid bacteria in the almond milk produced from the protein enrichment process; a raw material measuring and adding process for weighing almond milk, coconut oil, modified starch, stabilizer, acidity regulator, salt, and paprika extract produced from the almond milk fermentation process; a sterilization & emulsification process of cooking/emulsifying/sterilizing the raw materials weighed in the raw material measuring and adding process by putting them into a cheese cooker; a cooling & packaging process for transporting the colloidal emulsification/sterilization liquid prepared from the sterilization & emulsification process to a packaging machine and packaging/cooling; and a ripening process for aging the vegetable cheese produced from the cooling & packaging process.

In an exemplary embodiment, the almond extraction process is made at low temperature to prevent rancidity/deterioration of almonds, and minimize fat content by extracting with high moisture content to prevent precipitation and rancidity caused by almond fat coagulated with protein solids during extraction.

In an exemplary embodiment, the almond protein enrichment process is a process of adding almond protein to the almond extracting milk at a weight ratio of 1:0.05 to 1:0.15.

In an exemplary embodiment, the almond milk fermentation process is a process of adding vegetable mixed lactic acid strains to almond milk at a ratio of 1:0.02 to 0.04 by weight of almond milk.

In an exemplary embodiment, the raw material measuring and adding process is a process of adding, coconut oil at a ratio of 1:0.12-0.3, modified starch 1:0.1-0.25, stabilizer 1:0.001-0.02, salt 1:0.01-0.02, and paprika extract 1:0.00001-0.00009 by weight to fermented almond milk.

In an exemplary embodiment, the sterilization & emulsification process uses a direct steam injection cooker to bring out the flavor of fermented almond milk, and a knife-type churning blade churns at high speed for a texture similar to cheese, and includes a vacuum process to prevent off-flavor and rancidity of the fat.

In an exemplary embodiment, in the sterilization & emulsification process, direct steam sterilization is performed at 88° C.±3 for sterilization and emulsification of almond milk, the churner uses a knife-type churner, and the churning speed is 800 rpm to 2,500 rpm for high-speed churning, and vacuum level of 500-700 bar is maintained.

In an exemplary embodiment, the sterilization & emulsification process further includes a post-churning process to refine the texture of vegetable cheese, and the post-churning time of the post-churning process is maintained at 120 to 480 seconds, and the temperature, churning conditions, churning speed, and vacuum are maintained the same as sterilization & emulsification conditions.

In an exemplary embodiment, the cooling & packaging process is a process wherein the sterilized emulsified emulsion is cooled after packaging in any one packaging container among blocks, portions, slices, and spreadable pouches, filtered with a 50 to 100 mesh bag or SUS Filter to prevent foreign substances from entering the packaging container and to remove carbides, and using 10,000 gauss or more of magnetic force to remove iron foreign matter.

### Effects of the Invention

Thus, a method for making vegetable cheese using almonds according to an exemplary embodiment of the present invention is to realize the taste and texture of natural cheese by manufacturing vegetable cheese by fermenting almond milk and utilizing the Aroma Compound expressed in fermented almond milk, is possible to realize the taste, texture, and nutrients of natural cheese from vegetable cheese by reinforcing the lack of minerals and nutrients, especially protein, which are the disadvantages of vegetable cheese generally made with modified starch, with almonds.

In addition, the problem caused by fat generated during the almond extraction process was solved with high-moisture extraction, and by culturing a mixed strain of vegetable lactobacillus, rich Aroma Compound can be obtained from fermented almond milk.

### BRIEF DESCRIPTION OF THE DRAWINGS

FIG. 1 is a flowchart of a method for making vegetable cheese using almonds according to an exemplary embodiment of the present invention.

### DETAILED DESCRIPTION OF THE EMBODIMENTS

The terminology used herein will be described briefly, and the present invention will be described in detail.

The terminology used herein is defined in consideration of the function of corresponding components used in the present invention and may be varied according to users, operator's intention or practices. In addition, an arbitrary defined terminology may be used in a specific case and will be described in detail in a corresponding description paragraph. Therefore, the terminology used herein is for the purpose of describing particular embodiments only and is not intended to be limiting of the invention.

Throughout the specification, unless explicitly described to the contrary, the words “include” and “comprise” and variations such as “includes” or “including” and “comprises” or “comprising,” will be understood to imply the inclusion of stated elements but not the exclusion of any other elements. In addition, terms such as “part,” “module,” etc., which are described in the specification, mean a unit that processes at least one function or operation, and may be implemented as hardware or software, or a combination thereof.

In the following detailed description, only certain exemplary embodiments of the present invention have been shown and described, simply by way of illustration so that those skilled in the art can easily work the present invention. However, the described embodiments may be modified in various different ways, all without departing from the spirit or scope of the present invention. And in order to explicitly explain the present invention in the drawings, parts irrelevant to the description are omitted, and like reference numerals are designated like parts throughout the specification. Method for making vegetable cheese using almonds according to an exemplary embodiment of the present invention will be described more fully hereinafter with reference to the accompanying drawings.

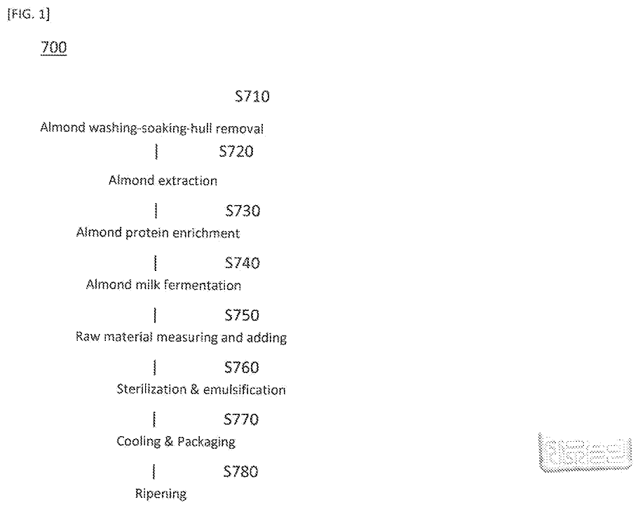

FIG. 1 is a flowchart of Method for making vegetable cheese using almonds according to an exemplary embodiment of the present invention.

Referring to FIG. 1, method for manufacturing vegetable cheese using almonds (S700) according to an exemplary embodiment of the present invention includes almond washing-soaking-hull removal process (S710), an almond extraction process (S720), almond protein enrichment process (S730), almond milk fermentation process (S740), raw material measuring and adding process (S750), sterilization & emulsification process (S760), cooling & packaging process (S770) and a ripening process (S780).

### 1. Almond Washing-Soaking-Hull Removal Process (S710)

It is a process of screening and washing almonds and then removing the hull through a soaking process in order to produce almond milk, wherein the almonds are soaked for 6 to 24 hours to wash foreign substances in the hull and remove the hull, and the almonds soaked in this way are removed from the hull by churning.

### 2. Almond Extraction Process (S720)

It is a process for producing almond milk by squeezing almonds from which hulls have been removed, and extracting almonds obtained through the almond washing/soaking/hull removal process (S710) through a extractor, wherein the almonds are extracted at a low temperature and since when almond fat is extracted, it may coagulate with solids such as protein and cause precipitation or rancidity, so it may be a process to minimize fat content by extracting with high moisture content.

### 3. Almond Protein Enrichment Process (S730)

It is a process of enhancing almond protein in extracted almond milk, wherein almond protein is added to the cold-pressed almond milk to enhance the protein of almond milk.

At this time, almond protein is added to the almond extracted milk at a weight ratio of 1:0.05 to 1:0.15.

### 4. Almond Milk Fermentation Process (S740)

It is a process of fermenting by mixing vegetable mixed lactic acid strains with squeezed almond milk, wherein fermented almond milk is produced by adding a vegetable mixed lactic acid strains to the extracted almond milk.

At this time, the vegetable mixed lactic acid strains are added to the almond milk at a ratio of 1:0.02-0.04 to the almond milk weight.

### 5. Raw Material Measuring and Adding Process (S750)

It is a process of measuring and adding vegetable cheese ingredients to fermented almond milk, and it may be a process of measuring and adding coconut oil, modified starch, stabilizer, acidity regulator, salt, paprika extract, etc. to the fermented almond milk, and at this time, the raw materials added to the fermented almond milk are added at the weight ratio of coconut oil 1:0.12 to 0.3, modified starch 1:0.1 to 0.25, stabilizer 1:0.001 to 0.02, salt 1:0.01 to 0.02, paprika extract 1:0.00001 to 0.00009.

### 6. Sterilization & Emulsification Process (S760)

It is a process of sterilization & emulsification by adding measured raw materials to fermented almond milk, wherein raw materials put into fermented almond milk are put into a cooker for cheese and sterilized and emulsified through high-speed churning.

At this time, the process conditions of the cooker for cheese is to use a direct steam injection cooker to preserve the flavor of fermented almond milk, and a knife-type churning blade churns at high speed for a soft and cheese-like texture, and adds a vacuum process to prevent off-taste, off-flavor, and rancidity of fat.

The sterilization and emulsification conditions of almond milk are direct steam sterilization at 88° C.±3, the churner uses a knife-type churner, churning speed is 800 rpm to 2,500 rpm for high-speed churning, and the vacuum maintains a degree of vacuum of about 500 to 700 bar.

Thereafter, a post-churning process is performed to make the texture of the vegetable cheese denser, the post-churning time is kept at 120 to 480 seconds, and the temperature, churning conditions, churning speed, and vacuum are maintained the same as the sterilization and emulsification conditions.

### 7. Cooling & Packaging Process (S770)

It is a process of measuring and putting raw materials into fermented almond milk, packing the sterilized and emulsified emulsion into a packaging machine, and then cooling it, wherein sterilized and emulsified emulsion is packed in packaging containers such as blocks, portions, slices, and spreadable pouches, and then cooled.

At this time, when transporting to the packaging machine, it is transported through the transport line and a 50 to 100 mesh bag or SUS filter is used to prevent foreign matter from entering and to remove carbides during transportation, and a magnet bar with a strength of 10,000 gauss or more is installed to remove iron foreign matter. In addition, packaged products are inspected for weight and foreign matter through weight inspection and X-RAY inspection.

### 8. Ripening Process (S780)

After the emulsified and sterilized emulsion is packaged in a packaging container, it is ripened at a refrigeration temperature of 0 to 8° C. to create a final texture. At this time, the ripening conditions must be carried out at the refrigeration temperature, and the ripening is about 5 to 10 days.

Thus, according to an exemplary embodiment of the present invention, it is to realize the taste and texture of natural cheese by manufacturing vegetable cheese by fermenting almond milk and utilizing the Aroma Compound expressed in fermented almond milk, and it is possible to realize the taste, texture, and nutrients of natural cheese from vegetable cheese by reinforcing the lack of minerals and nutrients, especially protein, which are the disadvantages of vegetable cheese generally made with modified starch, with almonds.

In addition, the problem caused by fat generated during the almond extraction process was solved with high-moisture extraction, and by culturing a mixed strain of vegetable lactobacillus, rich Aroma Compound can be obtained from fermented almond milk.

While this invention has been described in connection with what is practically considered to be exemplary embodiments, it is to be understood that it is intended to cover various modifications and equivalent arrangements by anyone skilled in the art without departing from the gist of the present invention included within the spirit and scope of the appended claims.

Accordingly, it is to be understood that the invention is not limited to the disclosed embodiments, but, on the contrary, exemplary embodiments introduced herein are provided to sufficiently transfer the spirit of the present invention. The scope of the present invention shall be determined only according to the attached claims, and all technical spirits within the equivalent scope shall be construed as being included in the scope of the present invention.

### DESCRIPTION OF SYMBOLS

S700: Method for making vegetable cheese using almonds
S710: Almond washing/soaking/hull removal process
S720: Almond extraction process
S730: Almond protein enrichment process
S740: Almond milk fermentation process
S750: Raw material measuring and adding process
S760: Sterilization/emulsification process
S770: Cooling/packaging process
S780: Ripening process

What is claimed is:

1. A method for making vegetable cheese using almonds comprising:
an almond washing-soaking-hull removal process of sorting/washing almonds to remove the skin;
an almond extraction process for producing almond milk by extracting almonds after the almond washing-soaking-hull removal process;
a protein enrichment process for enhancing almond protein in the almond milk extracted from the almond extraction process;
a almond milk fermentation process for producing vegetable fermented almond milk by using vegetable lactic acid bacteria in the almond milk produced from the protein enrichment process;
a raw material measuring and adding process for weighing almond milk, coconut oil, modified starch, stabilizer, acidity regulator, salt, and paprika extract produced from the almond milk fermentation process;
a sterilization & emulsification process of cooking/emulsifying/sterilizing the raw materials weighed in the raw material measuring and adding process by putting them into a cheese cooker;
a cooling & packaging process for transporting the colloidal emulsification/sterilization liquid prepared from the sterilization & emulsification process to a packaging machine and packaging/cooling; and
a ripening process for aging the vegetable cheese produced from the cooling & packaging process.

2. The method for making vegetable cheese using almonds of claim 1,
wherein the almond extraction process is:
made at low temperature to prevent rancidity/deterioration of almonds, and minimize fat content by extracting with high moisture content to prevent precipitation and rancidity caused by almond fat coagulated with protein solids during extraction.

3. The method for making vegetable cheese using almonds of claim 1,
wherein the almond protein enrichment process is:
adding almond protein to the almond extracting milk at a weight ratio of 1:0.05 to 1:0.15.

4. The method for making vegetable cheese using almonds of claim 1,
wherein the almond milk fermentation process is:
adding vegetable mixed lactic acid strains to almond milk at a ratio of 1:0.02 to 0.04 by weight of almond milk.

5. The method for making vegetable cheese using almonds of claim 1,
wherein the raw material measuring and adding process is:
adding, coconut oil at a ratio of 1:0.12-0.3, modified starch 1:0.1 to 0.25, stabilizer 1:0.001 to 0.02, salt 1:0.01 to 0.02, and paprika extract 1:0.00001 to 0.00009 by weight to fermented almond milk.

6. The method for making vegetable cheese using almonds of claim 1,
wherein the sterilization & emulsification process is:
using a direct steam injection cooker to bring out the flavor of fermented almond milk, and a knife-type churning blade churns at high speed for a texture similar to cheese, and including a vacuum process to prevent off-flavor and rancidity of the fat.

7. The method for making vegetable cheese using almonds of claim 6,
wherein the sterilization & emulsification process is:
performing direct steam sterilization at 88° C.±3 for sterilization and emulsification of almond milk, using a knife-type churner, and the churning speed is 800 rpm to 2,500 rpm for high-speed churning, and vacuum level of 500 to 700 bar is maintained.

8. The method for making vegetable cheese using almonds of claim 7,
wherein the sterilization & emulsification process further comprising:
a post-churning process to refine the texture of vegetable cheese, and the post-churning time of the post-churning process is maintained at 120 to 480 seconds, and the temperature, churning conditions, churning speed, and vacuum are maintained the same as sterilization & emulsification conditions.

9. The method for making vegetable cheese using almonds of claim 1,
wherein the cooling & packaging process is:
cooling the sterilized emulsified emulsion after packaging in any one packaging container among blocks, portions, slices, and spreadable pouches, filtering with a 50 to 100 mesh bag or SUS Filter to prevent foreign substances from entering the packaging container and to remove carbides, and using 10,000 gauss or more of magnetic force to remove iron foreign matter.
